(19) United States
(12) Patent Application Publication
(10) Pub. No.: US 2023/0169243 A1
(43) Pub. Date: Jun. 1, 2023

(54) Numerical Simulation Method for the Overflowing of River Channel Structures Based on Finite Volume Method

(71) Applicant: CHINA INSTITUTE OF WATER RESOURCES AND HYDROPOWER RESEARCH, BEIJING (CN)

(72) Inventors: Dawei ZHANG, BEIJING (CN); Juan LV, BEIJING (CN); Dongya SUN, BEIJING (CN); Qin JU, BEIJING (CN); Jingming HOU, BEIJING (CN); Liping MA, BEIJING (CN); Donglai LI, BEIJING (CN)

(21) Appl. No.: 17/954,335

(22) Filed: Sep. 28, 2022

(30) Foreign Application Priority Data
Nov. 29, 2021 (CN) 202111429722.5

(51) Int. Cl. G06F 30/28; G06F 30/23

(52) U.S. Cl. CPC G06F 30/28; G06F 30/23; G06F 2111/10

(57) ABSTRACT

The invention discloses a numerical simulation method for the overflowing of river channel structures based on finite volume method. The method firstly acquires plane geometric data, river section data and structure geometric sizes of the river channel. The river channel is discretized by using the one-dimensional finite volume element, and the primitive variable values are stored in the center of the element, wherein the position of the river channel structures is taken as the element special interface. The amount of water passing through the structure interface in each time step is calculated according to the structure overflowing formula. This amount of water is respectively deducted from and increased to the upstream element and the downstream element adjacent to the interface by applying the source item method. The primitive variable values at the special interface are reconstructed by adopting the non-reflection boundary conditions in order to ensure the continuity of calculation. The numerical flux at the structure interface is further calculated. According to the invention, the overflowing characteristics of each structure can be accurately reflected. Meanwhile, the calculation precision and stability of the one-dimensional river channel flow model are overall guaranteed, which provides a new solution for dealing with the overflowing of structures under the numerical framework of the one-dimensional finite volume method.

### CROSS-REFERENCE TO RELATED APPLICATION

The present application claims priority benefit to Chinese application No. 202111429722.5 filed on Nov. 29, 2021, the content of which is hereby incorporated by reference in its entirety.

### TECHNICAL FIELD

The invention relates to the field of hydraulic engineering, in particular to the field of flood control risk analysis, and more particularly, to a numerical simulation method for the overflowing of river channel structures based on finite volume method.

### BACKGROUND

A river channel structure refers to a structure that exists in a river channel, such as retaining weirs, river sluices, bridges and culverts, which have a significant impact on the water movement of the river. In engineering practice, a one-dimensional mathematical model is usually used to simulate the flow propagation occurred in the rivers. However, the water flow regime at the structure is extremely complex, and the control equation set used in the one-dimensional model cannot describe the complex water flow regime accurately. The structure is also known as a singularity within the computational domain and needs to be processed dedicatedly. In engineering practice, structures in river channels are very common. Therefore, whether the one-dimensional model can reasonably simulate the overflowing process of structures in the river channel determines whether the model can be popularized and applied on a large scale.

In the existing one-dimensional numerical simulation methods, the implicit finite difference method is regarded as the most popular numerical method for river flood simulation as it is developed earlier, originated in the 1960s. Common finite difference formats include Preissmann scheme, Abbott-Lonescu scheme, etc. Dealing with the structures in such model is completed by adding virtual sections and solving large sparse matrices. However, such numerical schemes based on implicit finite difference have no ability to capture shock waves and process excessive flow regimes. In some river channels with steep terrains and large slope changes, the numerical solution often diverges and even the simulation fails.

In recent years, the Godunov finite volume method based on solving the Riemann approximate solution has been widely applied in the field of flood numerical simulation. It can not only simulate the flow of river with a gentle slope, but also adaptively simulate the change of flow regime, and can also be well adapted to the river channel in a hilly area with a steep slope. Therefore, such method has been gradually developed into a new calculation scheme for simulating river flow. How to deal with the overflowing problem of river channel structures under the numerical framework of the new finite volume method is also a hot and difficult problem in this field at present.

### SUMMARY OF THE INVENTION

The objective of the invention is to provide a numerical simulation method for the overflowing of river channel structures based on finite volume method. According to this method, the overflowing characteristics of all structures can be accurately reflected under the numerical framework of the one-dimensional explicit finite volume method, while the precision and stability of overall calculation of the one-dimensional river channel flow model are guaranteed.

The invention is implemented through the following technical solutions.

A numerical simulation method for the overflowing of river channel structures based on finite volume method, which uses a one-dimensional finite volume element to discrete the river channel, and takes the position of the river channel structures as the special interface of the river calculation element. The amount of water passing through the interface in each time step is calculated according to the structure overflowing formula (e.g., weir flow formula, gate outflow formula, etc.). The amount of water is then respectively deducted from and increased to an upstream element and a downstream element adjacent to the interface by adopting a source item processing method. The primitive variable values at the special interface are numerically reconstructed in order to ensure the continuity of calculation. The method includes the following specific steps:

1) Obtaining basic data of river channels and structures: obtaining the plane geometric shape and control section shape data of the river channel, wherein the distance between adjacent sections is not greater than 1 km; obtaining the spatial position information and geometric size information of the river channel structure, and arranging two control sections on the upstream and downstream of the structure, wherein a distance between the sections is not more than 100 m;

2) Performing spatial discretization of the river channel: one-dimensional finite volume element is used to discretize the river channel, wherein the position of each section is the center position of the element, and the position of the midpoint of two sections is the element interface position. If there is no structure at the position, the interface is referred to as a conventional interface; if there is a structure at the position, the interface is referred to as a special interface. The primitive variable values of the river are stored in the center of the elements;

3) Initializing the calculation conditions: assigning initial primitive variable values to each element of the river channel, i.e., initial water level and initial flow value, setting the initial operating state of the structures, and obtaining the initial values of the upstream and downstream boundaries of the river channel;

4) Obtaining the outer boundary conditions at time t, and obtaining the calculation time step dt according to the CFL (Courant-Friedrichs-Lewy) condition;

5) Solving the numerical flux at each conventional interface, the overflow of the structure, and the numerical flux at the special interface: describing the river channel flow movement by using the Saint-Venant equations with source term; calculating the numerical flux at the conventional interface of each element at time t by using the finite volume method based on the HLL (Harten-Lax-van Leer) approximate Rieman solution; calculating the value of flow passing through the structure at time t by applying the primitive variable values of the upstream and downstream elements of the structure according to overflowing characteristics of structures (the overflowing characteristics are, for example, as follows: some structures are only controlled by the upstream water level, some are controlled by the water levels in upstream and downstream at the same time, some of the water flow passing through the structure are open channel flow, some are pressure flow, etc.), and processing the flow value as a source term of a continuity equation in the upstream and downstream elements; reconstructing the primitive variable values at the structure interface by using a non-reflection boundary condition in order to calculate the continuity of calculation, and then calculating the numerical flux passing through the special interface;

6) Obtaining the primitive variable values of each element at time t+dt: updating the primitive variable values at the center of each element at time t+dt through a numerical flux value at each element interface at time t and a source term value of overflowing of structures, and updating boundary conditions at both ends of the river channel synchronously to time t+dt;

7) Setting t=t+dt, and repeating the steps 4) to 6) until the end of the calculation. Further, in the step 4), the selection of dt is limited by the CFL condition, as shown in Formula (1):

$${N}_{cfl} = \frac{\vert u + c \vert}{Δ x / dt} \leq 1 \qquad ( 1 )$$

in which, N_{cfl} is the CFL number, u is the average flow velocity of the section, c is the wave velocity, Δx is the space step of the finite volume element, and dt is the time step.

Further, in the step 5), one-dimensional unsteady flows in a river channel considering the overflowing of the structure are described by the Saint-Venant equations with source term, as shown in Formula (2):

$$D \frac{\partial U}{\partial t} + \frac{\partial F}{\partial x} = S \qquad ( 2 )$$

in which, x is the space variable, t is the time variable, and D, U, F, and S are vector representations of variables in the equation set, to be specific:

$$D = [ \begin{matrix}B & 0 \\ 0 & 1\end{matrix} ] , U = [ \begin{matrix}Z \\ Q\end{matrix} ] , F ( U ) = [ \begin{matrix}{f}_{1} \\ {f}_{2}\end{matrix} ] = [ \begin{matrix}Q \\ \frac{{Q}^{2}}{A}\end{matrix} ] , S = [ \begin{matrix}{q}_{l} \\ - g A \frac{\partial Z}{\partial x} - g A J\end{matrix} ] ,$$

in which, B is the width of the water surface, Z is the water level, Q is the discharge Z and Q are called primitive variables, A is cross-sectional area, f₁ and f₂ represent two components of the vector F(U), respectively, g is the acceleration of gravity, J is the on-way resistance loss, with expression of J=(n²Q|Q|)/A²R^{4/3}), R is the hydraulic radius, n is the Maiming roughness coefficient, and q₁ is the source term value per unit length of the river channel.

Further, in the step 5), the overflow through the structure at time t is calculated through the primitive variable values of the upstream and downstream elements of the structure according to the overflowing characteristics of the structure. Taking the retaining weir in the river channel as an example, the overflowing calculation formula is shown in Formula (3):

$${q}_{w} = \{ \begin{matrix}0.35 * {h}_{u p} \sqrt{2 g {h}_{u p}} * l & ( if \frac{{h}_{down}}{{h}_{up}} \leq \frac{2}{3} ) \\ 0.91 * {h}_{down} {\sqrt{2 g ( {h}_{up} - {h}_{down} )}}^{*} l & ( if \frac{2}{3} < \frac{{h}_{down}}{{h}_{up}} \leq 1 )\end{matrix} \qquad ( 3 )$$

in which, hᵤₚ=Zᵤₚ−Z_{weir}; h_{down}=Z_{down}−Z_{wein}; q_{w} is the flow discharge passing through the structure; Zᵤₚ and Z_{down} are the water levels of calculation elements on the upstream and downstream of the structure, respectively; Z_{weir} is the weir crest elevation; and l is the weir width.

Further, in the step 5), the primitive variable values at the special interface are calculated by using the non-reflection boundary condition in order to ensure the continuity of calculation of all interface fluxes, to be specific: when the numerical fluxes of the upstream and downstream elements of the structure passing through the interface are calculated respectively, the primitive variable values at the interface are reconstructed as:

Z*=Zᵤₚ,Q*=0 (4)

Z*=Z_{down},Q*=0 (5)

in which, are the water level and the discharge after reconstruction at the element interface, respectively.

The invention has the following advantages and beneficial effects.

The method proposed in the invention can reflect the overflowing characteristics of each structure. Meanwhile, the precision and stability of the one-dimensional river channel flow model can also be guaranteed, thereby providing a new solution for dealing with overflowing process of structures under the numerical framework of a one-dimensional finite volume method.

### BRIEF DESCRIPTION OF THE DRAWINGS

The invention will be further described in conjunction with the attached figures and embodiments.

FIG. 1 is the flowchart of the numerical simulation method for the overflowing of river channel structures based on finite volume method;

FIG. 2 is the schematic diagram using finite volume element discretizing the river channel with structures;

in which, i−1, i and i+1 are the numbers of finite volume elements; i−1/2 and i+1/2 are left and right interfaces of the i^{th} element Δxᵢ is the length of the i^{th} finite volume element; and F*_{i-1/2} and F*_{i+1/2} are numerical fluxes passing through the left and right interfaces of the element;

FIG. 3 shows the numerical calculation results of an example of the river channel with a retaining weir.

### DETAILED DESCRIPTION OF THE INVENTION

### Embodiment 1

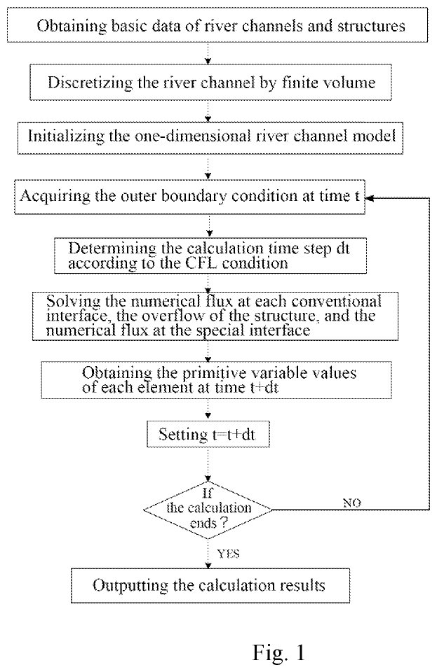

The invention will be further described in conjunction with FIG. 1 and embodiments.

The invention provides a numerical simulation method for the overflowing of river channel structures based on finite volume method, which uses a one-dimensional finite volume element to discrete the river channel, and takes the position of the river channel structures as the special interface of the river calculation element. The amount of water passing through the special interface in each time step is calculated according to the structure overflowing formula (e.g., weir flow formula, sluice gate outflow formula, etc.). The amount of water is then respectively deducted from and increased to an upstream element and a downstream element adjacent to the interface by adopting a source item processing method. The primitive variable values at the special interface are numerically reconstructed in order to ensure the continuity of calculation. The method can accurately reflect the overflowing characteristics of all structures under the numerical framework of the one-dimensional explicit finite volume method, while the precision and stability of overall calculation of the one-dimensional river channel flow model are guaranteed. The method includes the following specific steps:

1) Obtaining the plane geometric shape and control section shape data of the river channel, wherein the distance between adjacent sections is not greater than 1 km; obtaining the spatial position information and geometric size information of the river channel structure, and arranging two control sections on the upstream and downstream of the structure, wherein a distance between the sections is not more than 100 m;

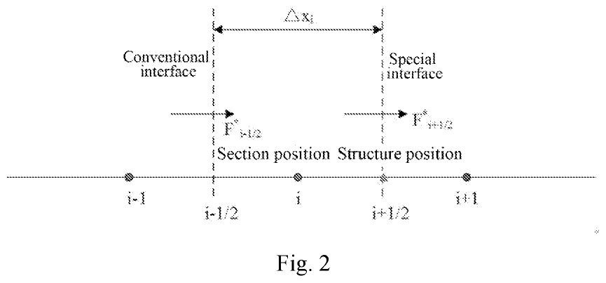

2) One-dimensional finite volume element is used to discretize the river channel, wherein the position of each section is the center position of the element, and the position of the midpoint of two sections is the element interface position. If there is no structure at the position, the interface is referred to as a conventional interface; if there is a structure at the position, the interface is referred to as a special interface. The primitive variable values of the river are stored in the center of the element. The details are plotted in FIG. 2;

3) Initializing the calculation conditions, assigning initial primitive variable values to each element of the river channel, i.e., initial water level and initial discharge, setting the initial operating state of the structures, and obtaining the initial values of the upstream and downstream boundaries of the river channel;

4) Obtaining the calculation time step dt according to the CFL (Courant-Friedrichs-Lewy) condition. The specific conditions of CFL are shown in Formula (1):

$${N}_{cfl} = \frac{\vert u + c \vert}{Δ x / dt} \leq 1 \qquad ( 1 )$$

in which, u is the average flow velocity of the section, c is a wave velocity, Δx is the space step of the finite volume element, and dt is the time step. In order to ensure the stability of the overall numerical calculation, N_{cfl} is recommended to be not exceeding 1.0.

5) Describing one-dimensional flows movement in a river channel considering the overflowing of the structure by using the Saint-Venant equations with source term, as shown in Formula (2):

$$D \frac{\partial U}{\partial t} + \frac{\partial F}{\partial x} = S \qquad ( 2 )$$

in which, x is the space variable, t is the time variable, and D, U, F, and S are vector representations of variables in the equation set, to be specific:

$$D = [ \begin{matrix}B & 0 \\ 0 & 1\end{matrix} ] , U = [ \begin{matrix}Z \\ Q\end{matrix} ] , F ( U ) = [ \begin{matrix}{f}_{1} \\ {f}_{2}\end{matrix} ] = [ \begin{matrix}Q \\ \frac{{Q}^{2}}{A}\end{matrix} ] , S = [ \begin{matrix}{q}_{l} \\ - g A \frac{\partial Z}{\partial x} - g A J\end{matrix} ] ,$$

in which, B is the width of the water surface, Z is the water level, Q is the discharge, Z and Q are called primitive variables, A is the cross-sectional area, f₁ and f₂ represent two components of the vector F(U), respectively, g is the acceleration of gravity, J is the on-way resistance loss, with expression of J=(n²Q|Q|)/(A²R^{4/3}), R is the hydraulic radius, n is the Manning roughness coefficient, and q₁ is the source term value per unit length of the river channel.

The numerical flux at the conventional interface of each element at time t is calculated by the finite volume method based on the HLL approximate Riemann solution. The detailed solution process of the HLL approximate Riemann solution can be found in the literature (Zhang Dawei, Cheng Xiaotao, Huang Jinchi, etc., “Widely adaptable numerical model for complicated open channel flows”, [J]. Journal of Hydraulic Engineering, 2010,41(4):531-536 (in Chinese), the content of which is herein incorporated by reference in its entirety; Zhang Dawei, Numerical Simulation of Dam Burst Flow Based on Godunov Format [M]. China Water&Power Press, Beijing, 2014,12, the content of which is herein incorporated by reference in its entirety).

The overflow through the structure at time t is calculated through the primitive variable values of the upstream and downstream elements of the structure according to the overflowing characteristics of the structure Taking the retaining weir in the river channel as an example, the overflowing calculation formula is shown in Formula (3):

$${q}_{w} = \{ \begin{matrix}0.35 * {h}_{u p} \sqrt{2 g {h}_{u p}} * l & ( if \frac{{h}_{down}}{{h}_{up}} \leq \frac{2}{3} ) \\ 0.91 * {h}_{down} {\sqrt{2 g ( {h}_{up} - {h}_{down} )}}^{*} l & ( if \frac{2}{3} < \frac{{h}_{down}}{{h}_{up}} \leq 1 )\end{matrix} \qquad ( 3 )$$

in which, hᵤₚ=Zᵤₚ−Z_{weir}; h_{down}=Z_{down}−Z_{weir}; q_{w} is the flow discharge passing through the structure; Zᵤₚ and Z_{down} are the water levels of calculation elements on the upstream and downstream of the structures; Z_{weir} is the weir crest elevation; and l is the weir width.

For different structures, the overflow at the current time can be obtained through the primitive variable values of their adjacent upstream and downstream elements. It should be noted that some structures have a definite overflowing formula can be used directly. While some structures are complicated in design, with no definite overflowing formula can be used. In this case, it is necessary to first acquire an overflowing curve formula of the structures through physical tests and other means, and then obtain the corresponding overflow based on the primitive variable values of the upstream and downstream of the structure. For a certain structure, the amount of water flowing from the upstream element of the structure at time t will inevitably enter the adjacent downstream element. The overflowing problem of the structure is considered by adding a source term in the governing equations, which can theoretically ensure the overall mass conservation characteristics of the mathematical model calculation. Meanwhile, this method can also ensure the stability of the calculation model.

The primitive variable values at the special interface are reconstructed by using the non-reflection boundary condition in order to ensure the continuity of calculation of all interface fluxes, to be specific: when the numerical fluxes of the upstream and downstream elements of the structure passing through the interface are calculated respectively, the primitive variable values at the interface are reconstructed as:

Z*=Zᵤₚ,Q*=0 (4)

Z*=Z_{down},Q*=0 (5)

in which, Z*, Q* are the primitive variable values at the element interface, Zᵤₚ is the water level of the upstream element of the structure, and Z_{down} is the water level of the downstream element of the structure.

According to the reconstructed primitive variable values at the special interface, the numerical flux through the special interface is further calculated.

6) Updating the primitive variable values at the center of each element at the time t+dt through a numerical flux value at each element interface at the time t and a source term value of overflowing of structures, and updating boundary conditions at both ends of the river channel synchronously to the time t+dt;

7) Setting t=t+dt, and repeating the steps 4) to 6) until the end of the calculation.

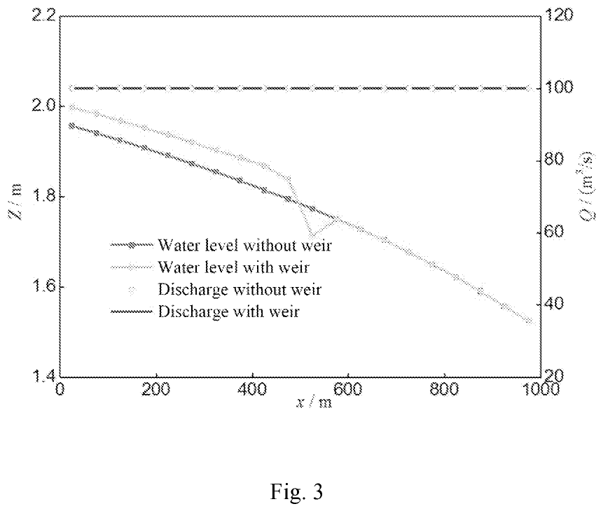

FIG. 3 shows the calculation result of the constant flow of a river with a retaining weir. The river is 1000 m long, 50 m wide, has a rectangular shape with a flat bottom. It has an upstream inflow Q=100 m³/s, and a downstream constant water level of 1.5 m. There is a retaining weir (50 m wide and 1.0 m high) at 500 m in the middle of the river. The river channel is discretized into 20 elements on average, wherein each element is 50 m long, and the Manning roughness coefficient is set to 0.025. It can be seen in FIG. 3 that the discharge calculated for each element is completely consistent with the theoretical value both without considering the retaining weir and considering the retaining weir, which is stable at 100 m³/s. It reveals that the method proposed in the invention for dealing with the structures can well guarantee the mass conservation characteristic of the mathematical model. From the water surface profile, the water level at the upstream end is stable at 1.957 m if the retaining weir is not considered. Considering the influence of the retaining weir, an obvious stagnant water effect occurs at the upstream of the retaining weir, with the upstream water level is stable at 1.998 m. In addition, it can be seen that there is an obvious water falling effect and the water level on the downstream of the retaining weir gradually returns to the original state after water flows through the retaining weir. The calculation results are consistent with the overflowing scenario of the real retaining weir. In summary, it is indicated that the numerical simulation method for the overflowing of the river channel structures based on finite volume method proposed by the invention is successful.

The above-mentioned embodiments are only a partial expression of the invention, and cannot cover the whole invention. On the basis of the above-mentioned embodiments and figures, those skilled in the field can obtain more embodiments without paying creative work. Therefore, these embodiments obtained without paying creative work should be included in the protection scope of the invention.

1. A numerical simulation method for the overflowing of river channel structures based on finite volume method, wherein by taking the position of the river channel structures as the special interface of the river calculation element, the amount of water passing through the interface in each time step is calculated according to the structure overflowing formula, and the amount of water is then respectively deducted from and increased to an upstream element and a downstream element adjacent to the interface by adopting a source item method; the method includes the following specific steps:
1) obtaining basic data of river channels and structures: obtaining the plane geometric shape and control section shape data of the river channel, wherein the distance between adjacent sections is not greater than 1 km; obtaining the spatial position information and geometric size information of the river channel structure, and arranging two control sections on the upstream and downstream of the structure, wherein a distance between the sections is not more than 100 m;
2) performing spatial discretization of the river channel: one-dimensional finite volume element is used to discretize the river channel, wherein the position of each section is the center position of the element, and the position of the midpoint of two sections is the element interface position; if there is no structure at the position, the interface is referred to as a conventional interface; if there is a structure at the position, the interface is referred to as a special interface; the primitive variable values of the river are stored in the center of the elements;
3) initializing the calculation conditions: assigning initial primitive variable values to each element of the river channel, i.e., initial water level and initial discharge, setting the initial operating state of the structures, and obtaining the initial values of the upstream and downstream boundaries of the river channel;
4) obtaining the outer boundary condition at time t, and obtaining the calculation time step dt according to the CFL condition;
5) solving the numerical flux at each conventional interface, the overflow of the structure, and the numerical flux at the structure interface: describing the river channel flow movement by using the Saint-Venant equations with source term; calculating the numerical flux at the conventional interface of each element at time t by using the finite volume method based on the HLL approximate Riemann solution; calculating the value of flow passing through the structure at time t by applying the primitive variable values of the upstream and downstream elements of the structure according to overflowing characteristics of structures, and processing the flow value as a source term of a continuity equation in the upstream and downstream elements; reconstructing the primitive variable values at the special interface by using a non-reflection boundary condition in order to ensure the continuity of calculation, and then calculating the numerical flux passing through the special interface;
6) obtaining the primitive variable values of each element at time t+dt: updating the primitive variable values at the center of each element at time t+dt through a numerical flux value at each element interface at time t and a source term value of overflowing of structures, and updating boundary conditions at both ends of the river channel synchronously to time t+dt;
7) setting t=t+dt, and repeating the steps 4) to 6) until the end of the calculation.

2. The numerical simulation method for the overflowing of river channel structures based on finite volume method according to claim 1, wherein the river channel structures comprise retaining weirs, sluice gates, bridges and culverts existing in the river channel.

3. The numerical simulation method for the overflowing of river channel structures based on finite volume method according to claim 1, wherein in the step 4), the selection of dt is limited by the CFL condition, as shown in Formula (1):
$${N}_{cfl} = \frac{\vert u + c \vert}{Δ x / dt} \leq 1 \qquad ( 1 )$$
in which, N_{cfl} is the CFL number, u is the average flow velocity of the section, c is the wave velocity, Δx is the space step of the finite volume element, and dt is the time step.

4. The numerical simulation method for the overflowing of river channel structures based on finite volume method according to claim 1, wherein in the step 5), the Saint-Venant equations with the overflowing source term of the structure are adopted as the governing equations, as shown in Formula (2):
$$D \frac{\partial U}{\partial t} + \frac{\partial F}{\partial x} = S \qquad ( 2 )$$
in which, x is the space variable, t is the time variable, and D, U, F, and S are vector representations of variables in the equation set, to be specific:
$$D = [ \begin{matrix}B & 0 \\ 0 & 1\end{matrix} ] , U = [ \begin{matrix}Z \\ Q\end{matrix} ] , F ( U ) = [ \begin{matrix}{f}_{1} \\ {f}_{2}\end{matrix} ] = [ \begin{matrix}Q \\ \frac{{Q}^{2}}{A}\end{matrix} ] , S = [ \begin{matrix}{q}_{l} \\ - g A \frac{\partial Z}{\partial x} - g A J\end{matrix} ] ,$$
in which, B is the width of the water surface, Z is the water level, Q is the discharge, Z and Q are called primitive variables, A is the cross-sectional area, f₁ and f₂ represent two components of a vector F(U), respectively, g is the acceleration of gravity, J is the on-way resistance loss, with expression of J=(n² Q|Q|)/(A²R^{4/3}), R is the hydraulic radius, n is the Maiming roughness coefficient, and q₁ is the source term value per unit length of the river channel.

5. The numerical simulation method for the overflowing of river channel structures based on finite volume method according to claim 1, wherein in the step 5), the overflow through the structure at time t is calculated through the primitive variable values of the upstream and downstream elements of the structure according to the overflowing characteristics; when the river channel structure is the retaining weir, the overflowing calculation formula is shown in Formula (3):
$${q}_{w} = \{ \begin{matrix}0.35 * {h}_{u p} \sqrt{2 g {h}_{u p}} * l & ( if \frac{{h}_{down}}{{h}_{up}} \leq \frac{2}{3} ) \\ 0.91 * {h}_{down} {\sqrt{2 g ( {h}_{up} - {h}_{down} )}}^{*} l & ( if \frac{2}{3} < \frac{{h}_{down}}{{h}_{up}} \leq 1 )\end{matrix} \qquad ( 3 )$$
in which, hᵤₚ=Zᵤₚ−Z_{weir}; h_{down}=Z_{down}−Z_{weir}; q_{w} is the flow discharge passing through the structure; Zᵤₚ and Z_{down} are water levels of calculation elements on the upstream and downstream of the structure; Z_{weir} is the weir crest elevation; and l is the weir width.

6. The numerical simulation method for the overflowing of river channel structures based on finite volume method according to claim 5, wherein in the step 5), the primitive variable values at the special interface is reconstructed by using the non-reflection boundary condition, to be specific: when the numerical fluxes of the upstream and downstream elements of the structure passing through the interface are calculated, the primitive variable values at the interface are reconstructed respectively as:
Z*=Zᵤₚ,Q*=0 (4)
Z*=Z_{down},Q*=0 (5)
in which, Z*, Q* are the water level and the discharge after reconstruction at the special interface, respectively.
